(19) United States
(12) Patent Application Publication
(10) Pub. No.: US 2023/0011201 A1
(43) Pub. Date: Jan. 12, 2023

(54) COMPOSITE MATERIAL COMPOSED OF A BIO-FILLER AND A THERMOPLASTIC MATRIX AND PROCESS FOR MAKING AN ARTICLE WITH SUCH COMPOSITE MATERIAL

(71) Applicant: UNIVERSITA' DEGLI STUDI DI MODENA E REGGIO EMILIA, Modena (IT)

(72) Inventors: Alessandro NANNI, Modena (IT); Massimo MESSORI, Modena (IT)

(21) Appl. No.: 17/778,991

(22) PCT Filed: Nov. 19, 2020
(86) PCT No.: PCT/IT2020/050286

§ 371 Date: May 23, 2022

(30) Foreign Application Priority Data
Dec. 3, 2019 (IT) 102019000022884

(51) Int. Cl. C08K 11/00; B29C 64/118; B29C 64/153; B33Y 10/00; B33Y 70/00; B33Y 80/00

(52) U.S. Cl. CPC C08K 11/005; B29C 64/118; B29C 64/153; B33Y 10/00; B33Y 70/00; B33Y 80/00; B29K 2511/00

(57) ABSTRACT

A composite material consisting of a bio-filler and a thermoplastic matrix is described. The bio-filler derives from the lees taken as solid/liquid residue from the bottom of containers containing wine or must, after fermentation, during storage or after any other treatment of wine or must, as well as after filtration, centrifugation or after any process of separation of wine or must. A process for obtaining such a bio-filler and three processes for obtaining an article with such a composite material is also described.

### CROSS-REFERENCE TO RELATED APPLICATIONS

This application is a U.S. national stage entry under 35 U.S.C. § 371 of PCT International Patent Application No. PCT/IT2020/050286, filed Nov. 19, 2020, which claims priority to Italian Patent Application No. 102019000022884, filed Dec. 3, 2019, the contents of which are incorporated herein by reference in their entirety.

### BACKGROUND OF THE INVENTION

### 1) Field of the Invention

The present invention refers to a composite material composed of a bio-filler and a thermoplastic matrix. Furthermore, the present invention relates to a process for making an article with such a composite material.

In general, the present invention refers to all thermoplastic materials such as polyesters, polyolefins, vinyl polymers, polyamides, thermoplastics deriving from starch or based on starch and thermoplastic elastomers (TPE).

### 2) Background Art

Thermoplastic composite materials are materials consisting of several components among which the polymeric matrix, the filler and (possibly/optionally) other additives present in smaller percentages are recognized. The filler is usually added to the polymer matrix for two reasons: to strengthen the polymer matrix and to lower its cost. Nowadays, as there is more and more interest in favour of the environment, the identification of a filler with natural and biodegradable origin, namely a bio-filler, usable on a large scale, for reinforcing and lowering the price of an existing polymer, can be very important in terms both of economy and of sustainability. However, the identification of a bio-filler capable of simultaneously improving the mechanical properties of a thermoplastic and being industrially scalable is not easy.

In literature, there are numerous studies that study the properties of a composite material obtained by adding a natural filler within a thermoplastic polymer. Examples may concern coffee waste, leather waste, hemp waste, cotton waste, wine stalks, etc.

In these studies there are cases in which the bio-filler improves the properties of the thermoplastic material (but the technique is difficult to reproduce on a large scale) or cases in which the bio-filler, which can be produced on a large scale, suffers from engineering/technological gaps and therefore cannot be mixed with the thermoplastic material.

However, in literature, nobody has ever before investigated and studied the effect of lees used as a bio-filler within a thermoplastic material.

It has been found that this dreg bio-filler is able to significantly improve the mechanical properties of thermoplastics and to be industrially scalable.

The state of the patent art is instead represented by patent application WO 2002/090440 A1 concerning a modifier for thermoplastic resins. In this patent application, a new substance capable of modifying thermoplastic materials and composites is disclosed. By defining the possible thermoplastic composites, the patent recalls, among the various possible fillers that can also be used, those deriving from wine lees. However, there are no patents that claim the direct use of lees waste as a low-cost reinforcing filler and degradation accelerator for thermoplastics.

### SUMMARY OF THE INVENTION

Object of the present invention is solving the aforementioned prior art problems by providing a class of composite materials manufactured by combining a thermoplastic polymer and the bio-filler.

The filler comes from a wine waste called lees. It is dried and ground and can be used as a low-cost natural filler for polymer matrices, especially biodegradable and bio-based ones. The filler is generally mixed in the molten state and the output product is a semi-finished product which can be sold and/or subsequently processed to obtain a finished product. The obtained composite material has improved mechanical properties such as increased stiffness and creep resistance, and is more easily biodegradable. Furthermore, its final cost can also be significantly lower. This is of great importance with bio-based and biodegradable materials as they, increasingly in demand, have difficulty in occupying important market spaces due to their high cost and their non-optimized properties.

An example can be the following. A polymer from renewable and biodegradable sources such as Poly (Butylene Succinate) (PBS) is ductile but not very rigid and has a cost on the market that varies between 5.0 and 10.0 Euro/kg. The bio-filler has a cost that varies between 0.05 and 0.12 Euros/kg. The manufacturing process costs between 0.3 and 0.5 Euros/kg. So, for example, by mixing 30% wt. of bio-filler, on 100 kg of final product it is possible to obtain the following savings:

Case 1) (pure PBS) (100 kg (750.0 Euros (considered PBS cost 7.5 Euros/kg))

Case 2) PBS+30% wt (70*7.5+30*0.07+100*0.3=557.1 Euros

The advantages of such a process are: a saving of 25.72%, a material totally made up of renewable sources, a material that is always biodegradable and indeed with better kinetics, a reinforced material thanks to greater stiffness and greater resistance to creep.

Improvements and advantages compared to current or alternative technologies: industrialization of a natural, biodegradable and low-cost filler, coming from the wine sector, one of the best performing sectors in Italy, and in Europe in general. This leads to the advantages of not having logistic transport problems and not having problems related to the scarcity of material. For example, in Emilia-Romagna alone, about 50-60 million kg of waste are generated every year that can be transformed into bio-filler.

The aforementioned and other purposes and advantages of the invention, which will appear from the following description, are achieved with a composite material composed of a bio-filler and a thermoplastic matrix, with a process for making a bio-filler of a composite material and with a process for making an article with such a composite material as claimed in the respective independent claims. Preferred embodiments and non-trivial variants of the present invention are the subject of the dependent claims.

It is understood that all attached claims form an integral part of the present description.

It will be immediately obvious that numerous variations and modifications (for example relating to shape, dimensions, arrangements and parts with equivalent functionality) can be made to what is described, without departing from the scope of the invention as appears from the attached claims.

A composite material consists of a bio-filler and a thermoplastic matrix.

### DETAILED DESCRIPTION OF PREFERRED EMBODIMENTS

Advantageously, the bio-filler derives from the lees taken as solid/liquid residue from the bottom of containers containing wine or must, after fermentation, during storage or after any other treatment of wine or must, as well as after filtration, centrifugation or after any process of separation of wine or must.

The bio-filler has a mass content between 0.5 and 95%, while the thermoplastic matrix has a mass content between 5 and 99.5%.

The thermoplastic matrix includes all polyesters of both petrochemical and biomass origin, bio-based, as well as those directly synthesized by microorganisms.

The thermoplastic matrix includes all polyolefins of both petrochemical and biomass origin, bio-based.

The thermoplastic matrix includes all vinyl polymers of both petrochemical and biomass origin, bio-based.

The thermoplastic matrix includes all polyamides of both petrochemical and biomass origin, bio-based.

The thermoplastic matrix includes all thermoplastic elastomers, TPE, of both petrochemical and biomass origin, bio-based.

Thermoplastic polyester includes: polylactic acid (PLA), poly (butylene succinate) (PBS), poly (butylene adipate terephthalate) (PBAT), poly (ethylene terephthalate) (PET), poly (caprolactone) (PCL), poly (trimethylene terephthalate) (PTT), poly (butylene terephthalate) (PBT), polyglycolic acid (PGA), and poly (hydroxyalkanoates) (PHAs), including in particular short-chain poly (hydroxyalkanoates) (scl-PHAs) such as poly (β-hydroxybutyrate) (PHB) and its copolymers, such as poly (β-hydroxybutyrate-co-hydroxyvalerate) (PHBV) and poly (β-hydroxybutyrate-co-hydroxyhexanoate) (PHBH).

Thermoplastic polyolefin includes: polyethylene (PE), low density polyethylene (LDPE), medium density polyethylene (MDPE), high density polyethylene (HDPE), ultra-high molecular weight polyethylene (UHMWPE), linear low density polyethylene (LLDPE), linear medium density polyethylene (LMDPE), metallocene-based polyethylene (mPE) and polypropylene (PP).

The vinyl polymer includes: polystyrene (PS), high impact polystyrene (HIPS), expanded polystyrene (EPS), polyvinyl chloride (PVC), plasticised polyvinyl chloride (PVC-P) and polymethyl methacrylate (PMMA).

Polyamide includes: polyamide 11 (PA11), polyamide 6 (PA6), polyamide 6.6 (PA6.6), polyamide 12 (PA12), polyamide 6.10 (PA6.10), polyamide 6.12 (PA6.12), polyamide 10.10 (PA10.10) and polyamide 10.12 (PA10.12).

The thermoplastic elastomeric matrix comprises thermoplastic elastomers (TPE) such as: poly (styrene-b-ethylene-co-butylene-b-styrene) (SEBS) and poly (styrene-b-butylene-b-styrene) (SBS).

The thermoplastic matrix comprises a starch and/or a thermoplastic starch (TPS) and/or a starch derivative.

The composite material comprises a plurality of minor additive components, taken individually or combined to form a mixture, such as plasticizers (0-20% by mass), dyes (0-10% by mass), coupling agents (0-10% by mass), thermal stabilizers (0-2% by mass), UV stabilizers (0-2% by mass), lubricants (0-10% by mass), nucleating agents (0-15% by mass), compatibilizers (0-10% by mass), flame retardant (0-10% by mass) and other additives modifying the properties of the polymer and/or the process.

The composite material comprises a thermoplastic material such as acrylonitrile butadiene styrene (ABS), cellulose acetate (CA), cellulose acetate butyrate (CAB), cellulose nitrate (CN), polyacrylonitrile (PAN), polycarbonates (PC), polyether ether ketone (PEEK), polyether sulfone (PES), polyimide (PI), polyparaphenylene sulfide

(PPS), polyparaphenylene sulfone (PPSU), polysulfone (PSU), polytetrafluoroethylene (PTFE), polyvinyl acetate (PVAC), polyvinyl alcohol) polyvinylidene fluoride (PVDF), styrene-co-acrylonitrile (SAN), thermoplastic polyurethanes (TPU), EPDM rubbers, polyisobutylene (PIB) and olefin thermoplastic elastomers (TPO).

A process for making a bio-filler of a composite material includes the following steps:
the initially moist lees (30-95% by mass of aqueous substance) are separated from the liquid fraction by means of a centrifuge and/or press-filter;
the dehumidified lees (20-50% by mass of aqueous substance) are completely dried in a rotary drum dryer (0-10% by mass of aqueous substance);
the dried lees are ground and screened to obtain a particle size in the order of 0.1-500 microns, possibly using a pulverizer.

A first process for making an article with a composite material concerns semi-finished or finished products, such as solid sections, hollow sections, sheets, panels, films, filaments, granules (pellets) and powders. Such an article is made by means of single screw extrusion, twin screw extruder, internal mixer, open cylinder mixer and/or dry blending mixer.

A second process for making an article with a composite material relates to semi-finished or finished products in general. Such an article is made by thermoforming, injection moulding, rotational moulding and/or blow moulding.

A third process for making an article with a composite material relates to semi-finished or finished products in general. Such an item is made using both filament-powered additive manufacturing technologies, such as fused deposition modelling (FDM fused deposition modelling), granules (pellets) and powder such as selective laser sintering (SLS selective laser sintering).

An article made with a composite material concerns forks, knives, spoons, coffee and/or tea and/or other drink stirrers, glasses, shot glasses, goblets, plates, bottles, bags, envelopes, tea and/or herbal tea bags and/or infusions, food bags, capsules, coffee capsules, caps, caps for wine bottles, films, mulching films, films, jars, barrels, bottles, boxes, drums, vats, tubs, containers, containers, watering cans, tanks, wheelbarrows, handles, shovels, toys, beach toys (shovels, rakes, buckets, inflatables, rackets), filaments, vine lines, lawn mower lines, composters, buckets, toothbrushes, hairbrushes, insoles for shoes, shoes, strings, clothes, sunglasses, eyeglasses, buttons, bags, belts, earrings, piercings, bracelets, rings, necklaces, wrist watches, cigarette holders, pipes, ashtrays, frames, laces, coffins, urns, wall clocks, chairs, tables, cabinets, fixtures, atta clothes, keyboards, mice, phone covers, cotton buds, hangers, syringes, combs, clothespins, cards, test tubes.

### Examples

In the last decade, the world of plastics has been revolutionizing due to the environmental problems associated with plastic pollution and the dependence on the “Oil & Gas” sector of conventional petrochemical plastics (fossil fuels running out and major emitters of CO2). For these reasons, materials from renewable sources (bio-based) and biodegradable have become of great interest both for industries and for the scientific academy. These dynamics have also led to an increase in the large-scale demand for bio-based and biodegradable products. However, the replacement of conventional plastic products is taking place gradually as these new renewable and natural products are not yet perfectly capable of competing with conventional petrochemicals in terms of costs and performance in order to secure important market shares. The use of cheap agro-industrial waste as natural fillers within bio-based and/or biodegradable polymers is certainly an excellent strategy to overcome this problem. With this approach, in fact, it is possible at the same time: a) to lower the price of the final product, b) to maintain the naturalness/degradability of the final product, c) to offer a new solution for the disposal and management of agro-industrial waste. Furthermore, this approach has environmental advantages even when applied to non-biodegradable synthetic polymers as, by doing so, the share of the final product deriving from petroleum can be significantly lowered. However, not all agro-industrial waste is capable of responding to the requisites necessary for these purposes, especially if conceived on an industrial level. Therefore, the identification of a promising bio-filler applicable on a large scale can lead to important future benefits both in economic and sustainability terms. To identify an optimal bio-filler, it is necessary both to carry out accurate laboratory tests that prove the effectiveness of the bio-filler in terms of mechanical and/or thermal properties and to investigate the real possibility of industrialization of the product. Only the combination of these two aspects is to be considered significantly important both at a scientific and at an industrial level. In literature, there are numerous studies in which the investigated bio-filler has interesting properties on a laboratory scale but with an impracticable scalability (the product, if scaled on a large scale, becomes exaggeratedly expensive, losing the essential feature of economy of the filler). Similarly, there are also cases in which the bio-filler, not difficult to scale on a large scale, has mechanical or processability gaps that make its use impossible for technological reasons.

The bio-filler described herein, on the other hand, possesses both the necessary capabilities: it is technologically performing and its industrialization is not expensive.

The bio-filler in question derives from the wine waste called lees. With lees we mean any solid/liquid residue formed in the bottom of the containers containing the wine or must product, after fermentation, during storage or after any other permitted treatment concerning the product in question, as well as the residue obtained after any filtration process. or centrifuge of this product (wine/must) (Council Regulation (EEC) No. 337/79). The lees thus defined, in any way ground and dried, constitute the bio-filler.

The bio-filler object of the present invention has the following characteristics which are indispensable for its use on a large scale:
low cost;
not in competition with nutrition;
inherently non-toxic/dangerous;
abundantly and annually available;
technologically pre-treatable, desiccable, grindable, transportable;
compatible with most polymeric materials in terms of processability, and so on.

The bio-filler object of the present invention has the following physicochemical properties:
resistant and stable at high temperatures (250-280° C.);
mixable in high quantities (5-90% wt.) with the starting thermoplastic;
reinforcing, helping to improve the mechanical properties of the starting polymer in terms of stiffness and resistance to creep;
biodegradability accelerator, when mixed with biodegradable polymers it increases the biodegradation rate.

After being dried and ground, the bio-filler object of the present invention can be used for the manufacture of new thermoplastic composites through the use of a twin screw and/or single screw extruder and/or internal mixer and/or any other compounding process in the melt and not.

According to a variation, the bio-filler can be mixed with the polymer directly in the injection printer and/or injection printer with compounder, both single and double screw, IMC.

In particular, the formulation involves the use of:

Major components (A):
5-95% wt. of any thermoplastic matrix (including thermoplastic elastomers (TPE)) that can be processed at temperatures below 300° C. (or a mixture thereof), with particular attention to polyolefins of both: petrochemical origin; biological (bio-based): for example, polyethylene (PE/bio-PE), polypropylene (PP/bio-PP), polyesters, bio-polyesters, for example, short-chain poly (hydroxyalkanoates) (scl-PHAs such as PHB and its copolymers such as PHBV and PHBH), poly (butylene succinate) (PBS), poly (butylene adipate terephthalate) (PBAT), polyamides (e.g. PA11) and poly (lactic acid) (PLA), starch or based thermoplastics starch and thermoplastic TPE elastomers (eg. styrene-ethylene/butylene-styrene (SEBS) or styrene-butylene-styrene (SBS)).
0.5-90% wt. of the bio-filler.

Minor components (B):
0-10% wt. plasticizer;
0-10% wt. dye (e.g. titanium dioxide);
0-5% wt. coupling agent (e.g. silane);
0-2% wt. thermal stabilizer (eg Irganox 1010);
0-10% wt. other additives (eg calcium carbonate).

A further object of the present invention is a thermoplastic composite material obtained from any combination of one or more (mixture, blend) major components A (5-95% wt.) and the major component B (5-90% wt.), regardless of the type of process adopted for the manufacture of this composite material, regardless of the presence or absence of other components (minor or other) and regardless of the treatments performed on one or more components.

Industrial applications of the compound containing the bio-filler.

The compound obtained by mixing the materials with a higher component A and B using a twin screw and/or single screw extruder and/or internal mixer, and/or any other compounding process in the molten and non-melted state, can be used for any other subsequent forming process depending on the shape of the compound (pellet, sheet, wire, etc.), the properties possessed by the compound itself and the final desired properties. Examples of forming may concern: injection moulding, additive manufacturing using FDM technology (Fusion Deposition Modelling), extrusion of profiles, thermoforming, rotational moulding, etc.

In terms of finished product and industrially speaking, the range of possibilities of use of the thermoplastic composite containing the bio-filler is very wide and affects many sectors depending on the final properties of the product (which vary with the choice of the major component A and with the quantity of major component B, or the bio-filler). Despite this wide range, it is advisable to pay attention to the following final products: cutlery, plates, disposable glasses, films, toothbrushes, rigid reusable glasses, corks, stoppers for wine bottles; biodegradable hunting cartridges; mulching film; underground pots, coffee capsules.

In general, any product generally manufactured with thermoplastic materials deriving from petrochemical and non-biodegradable sources that must perform packaging and/or commodity functions for short (disposable) or medium times can be replaced with thermoplastic composites containing the bio-filler. This also applies to the agricultural sector, where readily biodegradable products can be of particular use.

Examples of formulations instead concern the following cases:
a. Composite material:
Poly (butylene succinate) (PBS), CAS No: 25777-14-4, mass 40-99.5%;
Bio-filler, %, mass 0.5-60%;
b. Composite material:
Poly (butylene succinate) (PBS), CAS No: 25777-14-4, mass 40-99.5%;
Bio-filler, %, mass 0.5-60%;
3-Methacryloxypropyltrimethoxysilane, CAS No: 2530-85-0, mass 0-5%;
Titanium dioxide, CAS No: 3463-67-7, mass 0-5%.
c. Composite material:
Poly (hydroxybutyrate-co-hydroxyvalerate) (PHBV), CAS No: 80181-31-3, mass 40-99.5%;
Bio-filler, mass 0.5-60%.
d. Composite material:
Poly (hydroxybutyrate-co-hydroxyhexanoate) (PHBH), CAS No: 147398-31-0, mass 40-99.5%;
Bio-filler, mass 0.5-60%;
3-Methacryloxypropyltrimethoxysilane, CAS No: 2530-85-0, mass 0-5%.
e. Composite material:
Polyamide 11 (PA11), CAS No: 25035-04-5, mass 50-99.5%;
Bio-filler, mass 0.5-50%;
3-Methacryloxypropyltrimethoxysilane, CAS No: 2530-85-0, mass 0-5%.
f. Composite material:
Poly (Lactic Acid) (PLA), CAS No: 26100-51-6, mass 40-99.5%;
Bio-filler, mass 0.5-60%;
g. Composite material:
Styrene-b-Ethylene-co-Butylene-b-Styrene (SEBS), CAS No: 66070-58-4, mass 20-99.5%;
Bio-filler, mass 0.5-80%;
h. Composite material:
Styrene-b-butylene-styrene (SBS), CAS No: 91261-65-3, mass 10-99.5%;
Bio-filler, mass 0.5-90%;
i. Composite material:
Poly (butylene succinate) (PBS), CAS No: 25777-14-4, mass 5-75%;
Poly (Lactic Acid) (PLA)-CAS No: 26100-51-6, mass 5-75%;
Bio-filler, mass 5-60%;
Titanium dioxide, CAS No: 3463-67-7, mass 0-5%.
j. Composite material:
Poly (butylene succinate) (PBS), CAS No: 25777-14-4, mass 5-75%;
Poly (hydroxybutyrate-co-hydroxyvalerate) (PHBV), CAS No: 80181-31-3, mass 5-75%;
Bio-filler, mass 5-60%;
Titanium dioxide, CAS No: 3463-67-7, mass 0-5

1-20. (canceled)

21. A composite material composed of a bio-filler and a thermoplastic matrix, wherein the bio-filler derives from wine lees racked as solid/liquid residues from the bottom of vessels containing wine or must after the fermentation, during the storage or after any other treatment of the wines or musts, as well as after filtration, centrifugation or after any other separation process concerning wines or musts.

22. The composite material of claim 21, including the bio-filler with a mass content ranging from 0.5 to 95% and a thermoplastic matrix with a mass content ranging from 5 to 99.5%.

23. The composite material of claim 22, wherein the thermoplastic matrix includes all polyesters, derived both from petrochemicals and from biomasses, bio-based, as well as polyesters directly synthetized by microorganisms.

24. The composite material of claim 22, wherein the thermoplastic matrix includes all polyolefins derived both from petrochemicals and from biomasses, bio-based.

25. The composite material of claim 22, wherein the thermoplastic matrix includes all vinyl polymers derived both from petrochemicals and from biomasses, bio-based.

26. The composite material of claim 22, wherein the thermoplastic matrix includes all polyamides derived both from petrochemicals and from biomasses, bio-based.

27. The composite material of claim 22, wherein the thermoplastic matrix includes all thermoplastic elastomers, TPE, derived both from petrochemicals and from biomasses, bio-based.

28. The composite material of claim 23, wherein that thermoplastic polyester includes: poly(lactic acid), PLA, poly(butylene succinate), PBS, poly(butylene adipate terephthalate), PBAT, poly(ethylene terephthalate), PET, poly(caprolactone), PCL, poly(trimethylene terephthalate), PTT, poly(butylene terephthalate), PBT, poly(glycolic acid), PGA and poly(hyroxyalkanoate), PHA, including in particular short-chain-length poly(hyroxyalkanoate), scl-PHA, as poly(β-hydroxybutirrate), PHB and its copolymers as poly(β-hydroxybutirrate-co-hydroxyvalerate), PHBV and poly(β-hydroxybutirrate-co-hydroxyexanoate), PHBH.

29. The composite material of claim 24, wherein the thermoplastic polyolefin includes: polyethylene, PE, low-density polyethylene, LDPE, medium-density polyethylene, MDPE, high-density polyethylene, HDPE, ultra-high molecular weight polyethylene, UHMWPE, linear low-density polyethylene, LLDPE, linear medium-density polyethylene, LMDPE, metallocene polyethylene, mPE and polypropylene, PP.

30. The composite material of claim 25, wherein the thermoplastic vinyl polymer includes: polystyrene, PS, high-impact polystyrene, HIPS, expanded polystyrene, EPS, poly(vinyl chloride), PVC, plasticized poly(vinyl chloride), PVC-P and poly(methyl methacrylate), PMMA.

31. The composite material of claim 26, wherein polyamide includes: polyamide 11, PA11, polyamide 6, PA6, polyamide 6.6, PA6.6, polyamide 12, PA12, polyamide 6.10, PA6.10, polyamide 6.12, PA6.12, polyamide 10.10, PA10.10 and polyamide 10.12, PA10.12.

32. The composite material of claim 27, wherein the thermoplastic elastomer, TPE includes: poly(styrene-b-ethylene-co-butylene-b-styrene), SEBS, and poly(styrene-b-butylene-b-styrene), SBS.

33. The composite material of claim 22, wherein the thermoplastic matrix includes: starch, thermoplastic starches, TPS, and/or a starch derivate.

34. The composite material of claim 22, including multiple minor additive components, taken individually or combined to form a mixture, such as plasticizers in a range of 0-20% in weight, colorants in a range of 0-10% in weight, coupling agents in a range of 0-10% in weight, thermal stabilizers in a range of 0-2% in weight, UV stabilizers in a range of 0-2% in weight, lubricants in a range of 0-10% in weight, nucleating agents in a range of 0-15% in weight, compatibilizers in a range of 0-10% in weight, flame retardants in a range of 0-10% in weight and any other additive or filler utilized to modify both polymer properties and polymer processing.

35. The composite material of claim 2, wherein the thermoplastic matrix includes: acrylonitrile-butadiene-styrene, ABS, cellulose acetate, CA, cellulose acetate butyrate, CAB, cellulose nitrate, CN, poly(acrylonitrile), PAN, polycarbonates, PC, polyether ether ketone, PEEK, polyether sulfone, PES, polyimide, PI, polyphenylene sulphide, PPS, polyphenylene sulfone, PPSU, polysulfone, PSU, polytetrafluoroethylene, PTFE, polyvinylidene acetate, PVAC, polyvinyl alcohol, PVA, polyvinylidene fluoride, PVDF, styrene-co-acrylonitrile, SAN, thermoplastic polyurethane elastomers, TPU, EPDM rubbers, polyisobutene, PIB and olefinic thermoplastic elastomers, TPO.

36. A process to produce a bio-filler of the composite material of claim 21, the process comprising the following steps:
the wine lees, initially wet, namely 30-95% in weight of aqueous solution, is separated from liquid fraction by the means of a centrifuge and/or a press-filter;
the dehumidified wine lees, namely 20-50% in weight of aqueous solution, is completely dried by means of a rotary-drum dryer, namely 0-10% in mass of aqueous solution;
the dried wine lees is grinded and sieved to obtain particles size ranging from 0.1 to 500 micron, eventually employing a pulverizer.

37. A process to produce an article made of the composite material of claim 21, the process obtaining semi-finished and finished products such as solid profiles, hollow profiles, sheets, panels, films, filaments, pellets and powders by single-screw extrusion, twin-screw extrusion, internal mixer, open cylinder mixer and/or dry blending.

38. A process to produce an article made of the composite material of claim 21, the process obtaining semi-finished and finished products by thermoforming, injection moulding, rotational moulding and/or blow moulding.

39. A process to produce an article made of the composite material of claim 21, the process obtaining semi-finished and finished products by additive manufacturing technologies fed both by filaments as in the case of the Fusion Deposition Modelling, FDM, technology, by pellets and by powders as in the case of the Selective Laser Sintering, SLS, technology.

40. An article made of the composite material of claim 21, the article including plastic cutlery as forks, knives and spoons, coffee and/or tea and/or beverage stirrers, glasses, cups, shots, calyxes, dishes, bottles, bags, bags for tea, food bags, capsules, coffee capsules, caps, corks, wine caps, wine corks, films, mulching films, skins, vessels, vases, jars, barrels, vials, flacons, flasks, tubs, pots, containers, cans, watering cans, tanks, wheelbarrow, handles, palette, toys, beach toys as buckets, spades, rakes, inflatables, rackets, filaments, wires for vineyards, wires for lawn mower, composters, bins, toothbrushes, hair brushes, shoes insoles, shoes, shoe strings, clothes, sun glasses, eyeglasses, buttons, handbags, belts, earrings, piercings, bracelets, rings, necklaces, wristwatches, mouthpieces, pipes, ashtrays, frames, laces, coffins, urns, wall clock, chairs, tables, cabinets, wardrobes, window frames, coat hangers, keyboards, mouse, phone cover, cotton bud, crutches, syringes, combs, clothespins, cards, test-pieces.
